(19) United States
(12) Patent Application Publication
(10) Pub. No.: US 2016/0307416 A1
(43) Pub. Date: Oct. 20, 2016

(54) APPARATUS, SYSTEM, AND/OR METHOD FOR MONITORING A DEVICE WITHIN A ZONE

(71) Applicant: Sennco Solutions, Inc., Plainfield, IL (US)

(72) Inventors: Christopher Marszalek, Plainfield, IL (US); Dale Russell Liff, Kent, OH (US); Stephen Michael Strom, North Olmsted, OH (US); Bill Johnson, Arlington Heights, IL (US); Kerry Berland, Arlington Heights, IL (US); Mark Kmiecik, Arlington Heights, IL (US)

(73) Assignee: Sennco Solutions, Inc., Plainfield, IL (US)

(21) Appl. No.: 14/853,510

(22) Filed: Sep. 14, 2015

Related U.S. Application Data
(63) Continuation-in-part of application No. 14/689,660, filed on Apr. 17, 2015.
Application No. 14/689,660 is a continuation-in-part of application No. 14/689,727, filed on Apr. 17, 2015.

(51) Int. Cl. G08B 13/14; G08B 25/10

(52) U.S. Cl. CPC G08B 13/1427; G08B 25/10

(57) ABSTRACT

An apparatus, a system and a method monitor a device within a zone. A head may wirelessly communicate with an emitter and a hub. The head may connect and/or disconnect power to a battery of the device according to a charge of the battery. The head may monitor an attachment of the head to the device and/or a connection of a cable to the head and/or a port of the device. The emitter may transmit a signal to define the zone and/or the head may receive the signal. A distance between the head and the emitter may be determined using a received signal strength indication and/or a time of flight measurement of the signal from the emitter to the head. The distance may indicate whether the head is positioned within the zone or outside of the zone. An alarm may be triggered if the head is positioned outside of the zone.

### CROSS-REFERENCE TO RELATED APPLICATIONS

This application is a continuation-in-part of pending U.S. patent application Ser. No. 14/689,660 and pending U.S. patent application Ser. No. 14/689,727, filed Apr. 17, 2015, the disclosures of which are hereby incorporated by reference. The disclosure of U.S. patent application Ser. No. ______ entitled “APPARATUS, SYSTEM AND METHOD FOR WIRELESSLY COLLECTING DATA CORRESPONDING TO A SECURITY DEVICE” concurrently filed with this application is hereby incorporated by reference.

### BACKGROUND OF THE INVENTION

The present invention generally relates to an apparatus, a system and/or a method for monitoring a device. The apparatus, the system, and/or the method may deter theft of the device and/or removal of the device. The apparatus, the system, and the method may allow the device to be used by an individual.

Generally, an individual prefers to use a device before buying the same. The device may be on display and/or for sale, for example, in a retail environment. The device may be a portable electronic device, such as, for example, a cellular telephone, a tablet computer, a laptop computer, a camera, a camcorder, a digital camera, a digital music player, a digital video player, a digital video recorder, a personal data assistant, an E-book, an E-reader and/or the like. Using the device may cause security concerns, such as theft and/or misappropriation of the device.

Known security systems may allow the individual to use the device while the device may be secured. The known security systems may secure the device to a display via a security tether, such as a cable. The display may be electronically connected by a cable to a sensor that may be attached to the device. The connection of the cable may be used to power the device and/or communicate with an alarm. The known security systems may alert the individual that the alarm has been triggered upon disconnection of the cable. The cable may have circuitry which may have a capacitance and/or may draw current. As a result, the known security systems may incorrectly determine that the device is connected to the cable, for example, using only capacitance sensing detection and/or only current sensing detection. Traditionally, while using the device secured by the known security systems, the device remains tethered to the display by the cable. As a result, the individual may be unable to use the device independent of the cable and/or the display. In addition, the known security systems may prevent the individual from examining characteristics of the device, such as, for example, its weight, its feel, and/or its portability. For example, known security systems may prevent the individual from placing the device in a pocket, a backpack, a purse and/or the like, to determine whether the device is suitable to the individual.

Moreover, the known security systems may continue to charge a battery that may power the device after the battery is charged. While the individual examines the device and/or the battery is continuously provided power, the battery may trickle charge, may start a charge cycle and/or stop a charge cycle. Continuing to charge the battery after the battery is charged may heat the battery which may reduce a usable lifetime of the battery.

A need, therefore, exists for an apparatus, a system and/or a method for monitoring a device within a zone. Additionally, a need exists for an apparatus, a system and/or a method for monitoring a device within a zone which may allow the individual to use the device within a distance from a display of the device. Moreover, a need exists for an apparatus, a system and/or a method for monitoring a device within a zone which may use wireless communication to monitor the device. Further, a need exists for an apparatus, a system and/or a method for monitoring a device within a zone which may trigger an alarm that may alert the individual that the device may be outside of the zone. Moreover, a need exists for an apparatus, a system and/or a method for monitoring a device that may cease charging after a battery of the device is charged which may prolong the usable lifetime of the battery. In addition, a need exists for an apparatus, a system and/or a method for monitoring a device that may detect a capacitance, a voltage and/or a current at a power port of the device to determine that the device is connected to a cable.

### SUMMARY OF THE INVENTION

The present invention generally relates to an apparatus, a system and/or a method for monitoring a device within a zone. Further, the apparatus, the system and/or the method for monitoring the device within the zone may have a hub, a head and/or an emitter.

To this end, in an embodiment of the present invention, an apparatus for monitoring a device within a first zone wherein the device is located inside of the first zone in a first position and further wherein the device is located outside of the first zone in a second position is provided. The apparatus may have a first emitter and a head. The first emitter may have a first transmitter that transmits a first signal to establish the first zone that extends from the first emitter. The head may be connected to the device wherein the head wirelessly communicates with the first emitter wherein the head has a first receiver that receives the first signal of a first strength indicative of the head in the first position and receives a second signal of a second strength indicative of the head in the second position wherein the head triggers a first alarm in the second position.

In an embodiment, the apparatus may have a hub wirelessly communicating with the first emitter and the head wherein the hub has a second receiver that receives the second signal and further wherein the hub triggers a second alarm in the second position of the head.

In an embodiment, the apparatus may have a cable having a length defined between a first end and a second end wherein the first end is connected to the device and the second end is connected to the head wherein the head provides power to the device through the cable.

In an embodiment, the apparatus may have a second emitter having a second transmitter that wirelessly communicates with the head and establishes a second zone and further wherein the second zone is adjacent to the first zone.

In an embodiment, the apparatus may have a battery having a charge and that powers the device wherein the head detects the charge of the battery.

In an embodiment, the apparatus may have a plunger associated with the head wherein the plunger extends from the head and triggers a third alarm indicative of separation of the head from the device.

In an embodiment, the apparatus may have a switch associated with the first emitter that adjusts a frequency of the first signal.

In an embodiment, the apparatus may have a circuit in the head configured to measure a voltage, a current and a capacitance at a port of the device.

In an embodiment, the apparatus may have an acceloremeter associated with the head wherein the acceloremeter indicates movement of the head.

In another embodiment of the present invention, a system for determining a proximity of a device to a first zone is provided. The system may have a first emitter, a head and/or a hub. The first emitter may have a first receiver that receives a first signal and a first transmitter that transmits a second signal to establish the first zone that extends from the first emitter. The head may be secured to the device wherein the head wirelessly communicates with the first emitter and has a second receiver that receives the second signal wherein the head calculates a distance between the head and the first emitter by determining a time the second signal travels between the first transmitter and the second receiver wherein the distance is indicative of a position of the head and further wherein the head triggers an alarm indicative of the head in a position outside of the first zone. The hub may be wirelessly communicating with the first emitter and the head wherein the head transmits a third signal to the hub that is indicative of the device in the position outside of the first zone.

In an embodiment, the system may have a cable having a length defined between a first end and a second end wherein the first end is connected to the device and the second end is connected to the head wherein the head triggers a second alarm indicative of a disconnection of the cable.

In an embodiment, the system may have a speaker in the head wherein the speaker emits an audible alert.

In an embodiment, the system may have a second emitter having a second transmitter wherein the second emitter wirelessly communicates with the head and establishes a second zone and further wherein the second zone intersects with the first zone.

In an embodiment, the system may have a key that inserts into the hub to deactivate the alarm.

In another embodiment of the present invention, a method for monitoring a device within a zone wherein the device wirelessly communicates with a first emitter and a hub and further wherein the zone extends a first distance from the first emitter is provided. The method may have the step of transmitting a signal wirelessly from the first emitter to define the zone wherein the first signal has a frequency. The method may have the step of calculating a second distance between the first emitter and the device. The method may have the step of comparing the first distance to the second distance. The method may have the step of triggering a first alarm if the second distance is greater than the first distance wherein the first alarm is indicative of the device in a position outside of the zone.

In an embodiment, the method may have the step of triggering a second alarm indicative of the device in the position located outside of the zone.

In an embodiment, the method may have the step of adjusting the frequency of the signal.

In an embodiment, the method may have the step of transmitting identification information of the device wherein the identification information is a manufacturer of the device and/or a model of the device.

In an embodiment, the method may have the step of monitoring a voltage, a capacitance and/or a current of the device.

In an embodiment, the method may have the step of deactivating the first alarm if the second distance is less than the first distance.

It is, therefore, an advantage of the present invention to provide an apparatus, a system and/or a method for monitoring a device within a zone.

Another advantage of the present invention is to provide an apparatus, a system and/or a method that may be used to deter theft of the device and/or removal of the device from the zone.

Further, an advantage of the present invention is to provide an apparatus, a system and/or a method for monitoring a device within a zone that may use wireless communication to monitor the device.

Moreover, an advantage of the present invention is to provide an apparatus, a system and/or a method for monitoring a device within a zone which may allow the device to be handled by an individual.

Yet another advantage of the present invention is to provide an apparatus, a system and/or a method for monitoring a device within a zone that may use a radio frequency signal to create the zone.

Further, an advantage of the present invention is to provide an apparatus, a system and/or a method for monitoring a device within a zone that may trigger an alarm upon removal of the device.

Another advantage of the present invention is to provide an apparatus, a system and/or a method for monitoring a device within a zone that may trigger an alarm upon removal of the device for a time that exceeds a threshold.

Yet another advantage of the present invention is to provide an apparatus, a system and/or a method for monitoring a device within a zone that may have a key that may insert into a hub to deactivate an alarm.

Moreover, an advantage of the present invention is to provide an apparatus, a system and/or a method that may monitor more than one device.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of a system for monitoring a device within a zone in an embodiment of the present invention.

FIG. 2 illustrates a perspective view of a head, an emitter, a hub and a display for monitoring a device within a zone in an embodiment of the present invention.

FIG. 3 illustrates a perspective view of a head, an emitter, a hub and a display for monitoring a device within a zone in an embodiment of the present invention.

FIG. 4 illustrates a perspective view of a hub and a key for monitoring a device within a zone in an embodiment of the present invention.

FIG. 5 illustrates a perspective view of a head for monitoring a device within a zone in an embodiment of the present invention.

FIG. 6. illustrates a perspective view of a head, a hub and an emitter for monitoring a device within a zone in an embodiment of the present invention.

FIG. 7 illustrates a black box diagram of a hub for monitoring a device within a zone in an embodiment of the present invention.

FIG. 8 illustrates a black box diagram of a head for monitoring a device within a zone in an embodiment of the present invention.

FIG. 9 illustrates a black box diagram of an emitter for monitoring a device within a zone in an embodiment of the present invention.

FIG. 10 illustrates a perspective view of a head, multiple emitters, a hub and a display for monitoring a device within multiple zones in an embodiment of the present invention.

FIG. 11 illustrates a perspective view of a head, multiple emitters, a hub and a display for monitoring a device within multiple zones in an embodiment of the present invention.

FIG. 12 illustrates a perspective view of a head, a hub, an emitter, a computer, a packet analyzer and a network for monitoring a device within a zone in an embodiment of the present invention.

### DETAILED DESCRIPTION

The present invention generally relates to a system and/or a method for monitoring a device. The apparatus, the system and/or the method may monitor a device within a zone via an emitter, a head and/or a hub. The emitter, the head and/or the hub may be in wireless communication. The head may have an adhesive for attaching the device to the head. The apparatus, the system and/or the method may deter removal of the device. The apparatus, the system and/or the method may allow an individual to use the device within a distance from a display of the device. The apparatus, the system and/or the method may trigger an alarm upon removal of the head and/or the device.

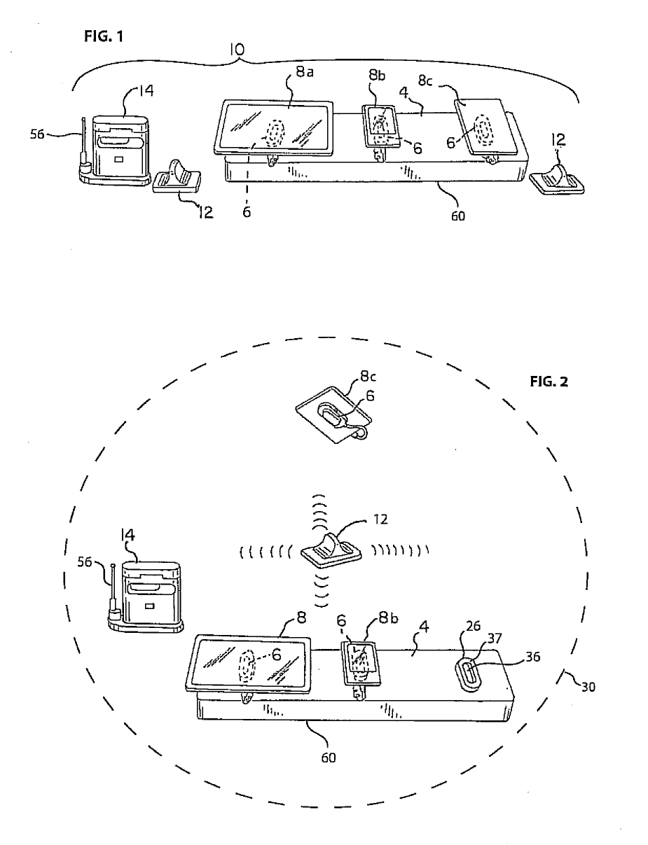

Referring now to the drawings wherein like numerals refer to like parts, FIG. 1 illustrates a system 10 which may monitor a device 8a, a device 8b and/or a device 8c (hereinafter collectively and individually referred to as “the device 8”) in an embodiment of the present invention. The device 8 may be on display and/or for sale, for example, in a retail environment. The device 8 may be a portable electronic device, such as, for example, a cellular telephone, a tablet or a laptop computer, a camera, a camcorder, a digital camera, a digital music player, a digital video player, a digital video recorder, a personal data assistant, an E-book, an E-reader and/or the like. In an embodiment, the device 8 may be a non-electronic device. The present invention should not be deemed as limited to a specific embodiment of the device 8. It should be understood that the device 8 may be any device that may be displayed and/or for sale in a retail environment as known to one having ordinary skill in the art.

In addition, as shown in FIG. 1, the system 10 may have a hub 14, one or more heads 6 and/or one or more emitters 12. The head 6, the emitter 12 and/or the hub 14 may be constructed from a material, such as, for example, plastic, thermoplastic, silicone, rubber, metal and/or the like and/or a combination thereof. The present invention should not be deemed as limited to a specific embodiment of the material of the head 6, the emitter 12 and/or the hub 14. It should be understood that the head 6, the emitter 12 and/or the hub 14 may be constructed from any material as known to one having ordinary skill in the art. The head 6 may be secured to the device 8. For example, an adhesive and/or the like may secure the head 6 to the device 8. The head 6 may have a top surface 17, as illustrated in FIG. 5. In addition, the device 8 may have a bottom surface 9, as illustrated in FIG. 5. The top surface 17 of the head 6 may be secured to the bottom surface 9 of the device 8.

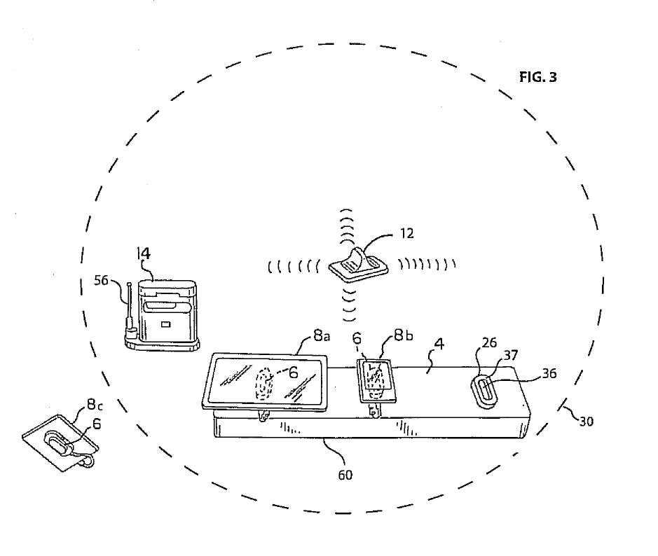

As illustrated in FIG. 1, in an embodiment of the present invention, the system 10 may have a display 60 for the device 8. The display 60 may have a base 4 and/or a cradle 26. The base 4 may be connected to the cradle 26 by, for example, screws, retaining clips, adhesive and/or the like. The cradle 26 may have a recess 36 and/or a top surface 37, as illustrated in FIGS. 2, 3, 10 and 11. The recess 36 may extend in an inward direction with respect to the top surface 37. The head 6 may have a projection 46 and/or a bottom surface 47, as illustrated in FIG. 5. The projection 46 may extend in an outward direction with respect to the bottom surface 47 of the head 6. The recess 36 may be sized to fit the projection 46 so that the head 6 and/or the device 8 may be docked on the display 60 in a first position of the head 6, as shown in FIG. 1. In the first position of the head 6, the top surface 37 of the cradle 26 may be in contact with the bottom surface 47 of the head 6. As shown in FIGS. 2, 3, 10 and 11, in a second position of the head 6, the head 6 and/or the device 8 may not be in contact with the display 60 and/or may be remote from the display 60.

The display 60 may provide power to and/or may charge the head 6 and/or the device 8, for example, when the head 6 and/or the device 8 are docked on the display 60. The display 60 may be connected to an AC power source (not shown). For example, the AC power source may be an AC power adapter that may be connected to an AC power outlet. Further, when the head 6 is docked, the head 6 may be rotated on the cradle 24 in various directions.

In an embodiment, a retractable cable (not shown) may secure the head 6 and/or the device 8 to the display 60. For example, the retractable cable may extend from the display 60 to the head 6 and/or the device 8 and/or may be connected to the display 60, the head 6 and/or the device 8. The display 60 and/or the retractable cable may provide power to and/or may charge the head 6 and/or the device 8. The retractable cable may be disconnected from the head 6 via a key 70, such as the key 70 shown in FIG. 5. In an embodiment, the key 70 may insert into the head 6 which may disengage the retractable cable from the head 6. For example, a retail store employee may insert the key 70 into the head 6. After disconnecting the head 6 from the retractable cable, the head 6 and/or the device 8 may be separated from the display 60. To reconnect the head 6 and/or the device 8 to the display 60 and/or the retractable cable, the head 6 may be placed on the cradle 26. After reconnecting the head 6 and/or the device 8 to the display 60 and/or the retractable cable, the head 6 and/or the device 8 may resume charging.

As shown in FIG. 6, the head 6 may wirelessly communicate with the emitter 12 and/or the hub 14. For example, the head 6, the emitter 12 and/or the hub 14 may use radio signals that may allow for wireless communication between the head 6, the emitter 12 and/or the hub 14. The radio signals may be, for example, high frequency and/or low frequency. The emitter 12 may wirelessly communicate with the hub 14 to transmit the radio signals that may establish a zone 30 that may extend from the emitter 12. As shown in FIGS. 2, 3, 10 and 11 the zone 30 may surround and/or be adjacent to the display 60 of the device 8. Movement of the head 6 and/or device 8 may be permitted within the zone 30. Removing the head 6 and/or the device 8 from the zone 30 may trigger a first alarm.

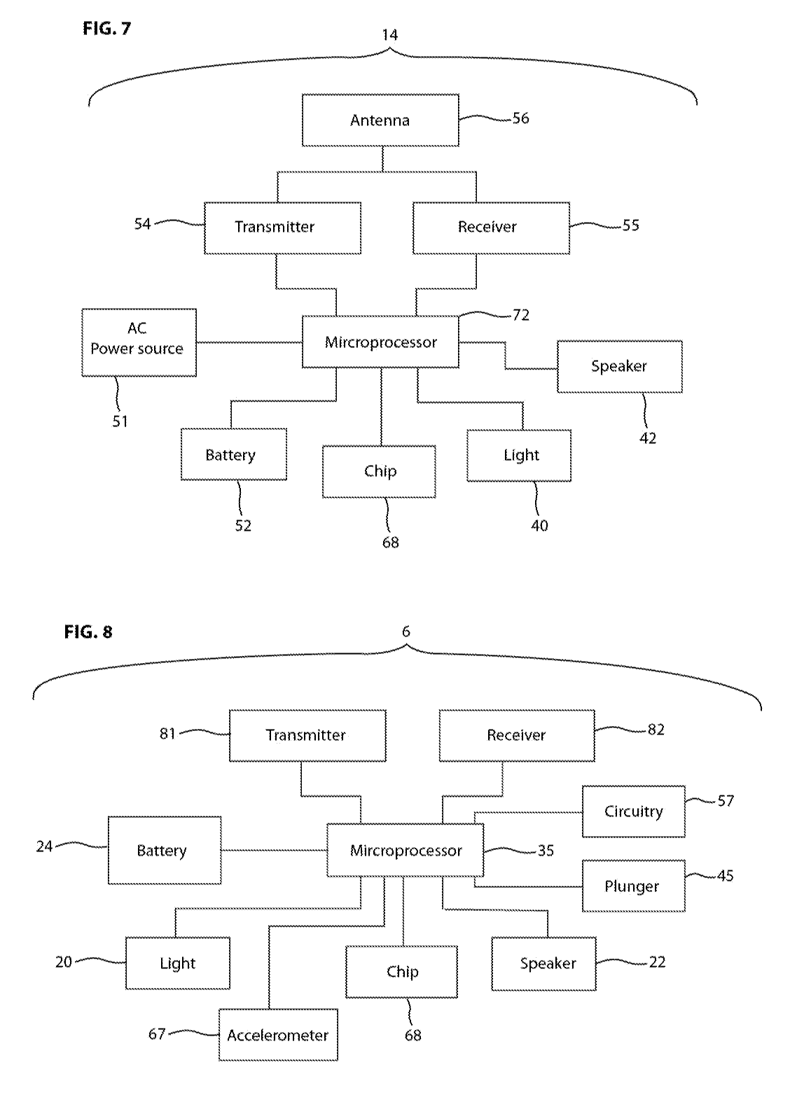

As illustrated in FIG. 7, the hub 14 may have a microprocessor 72 that may be housed within the hub 14 and/or secured to the hub 14. The microprocessor 72 and/or the hub 14 may be connected to an AC power source 51 and/or may be powered by the AC power source 51. For example, the AC power source 51 may be an AC power adapter that may be connected to an AC power outlet. In an embodiment of the present invention, the microprocessor 72 and/or the hub 14 may be powered by a battery 52. The microprocessor 72 may be programmed to wirelessly communicate with the head 6 and/or the emitter 12. A transmitter 54 may be connected to and/or controlled by the microprocessor 72. The transmitter 54 may wirelessly communicate with the head 6 and/or the emitter 12. The transmitter 54 may, for example, transmit signals to the head 6 and/or the emitter 12. Further, a receiver 55 may be connected to the microprocessor 72. The receiver 55 may wirelessly communicate with the head 6 and/or the emitter 12. For example, the receiver 55 may receive signals that may be transmitted by the head 6 and/or the emitter 12. The hub 14 may have an antenna 56 that may send and/or receive signals.

As illustrated in FIG. 8, the head 6 may have a microprocessor 35 in an embodiment of the present invention. The microprocessor 35 may be housed within the head 6 and/or secured to the head 6. The microprocessor 35 may be programmed to wirelessly communicate with the emitter 12 and/or the hub 14. A transmitter 81 may be connected to and/or controlled by the microprocessor 35. The transmitter 81 may wirelessly communicate with the emitter 12 and/or the hub 14. The transmitter 81 may, for example, transmit signals to the emitter 12 and/or hub 14. Further, a receiver 82 may be connected to the microprocessor 35. The receiver 82 may wirelessly communicate with the emitter 12 and/or the hub 14. For example, the receiver 82 may receive signals that may be transmitted by the head 6 and/or the emitter 12.

Further, the microprocessor 35 may, for example, be programmed to determine that the head 6 and/or the device 8 may be located within and/or outside of the zone 30. For example, the microprocessor 35 may be programmed to determine that the head 6 and/or the device 8 may be within the zone 30 when the receiver 82 may receive radio signals from the emitter 12. In addition, for example, the microprocessor 35 may be programmed to determine that the head 6 and/or the device 8 may be located outside of the zone when the receiver 82 fails to receive radio signals from the emitter 12. In an embodiment, a sensitivity of the head 6 and/or the receiver 82 to the wireless signals may be adjusted. The sensitivity of the head 6 and/or the receiver 82 may be adjusted to alter a proximity of the head 6 to the emitter 12 for which the head 6 receives the wireless signals from the emitter 12.

As illustrated in FIG. 8, the head 6 may have a battery 24 that may be housed within the head 6 and/or may be secured to the head 6. The battery 24 may be, for example, a rechargeable battery. The battery 24 may be connected to the microprocessor 35 and/or may power the microprocessor 35. In addition, the battery 24 may provide power to the device 8 through a cable 84, as illustrated in FIG. 5. The cable 84 may have a length defined between a first end 85 and/or a second end 86. The first end 85 of the cable 84 may have a first plug 95 for connecting the cable 84 to the head 6. The first plug 95 may be, for example, a USB plug and/or the like. The second end 86 of the cable 84 may have a second plug 96 for connecting the cable 84 to the device 8. The second plug 96 may be a USB plug and/or the like.

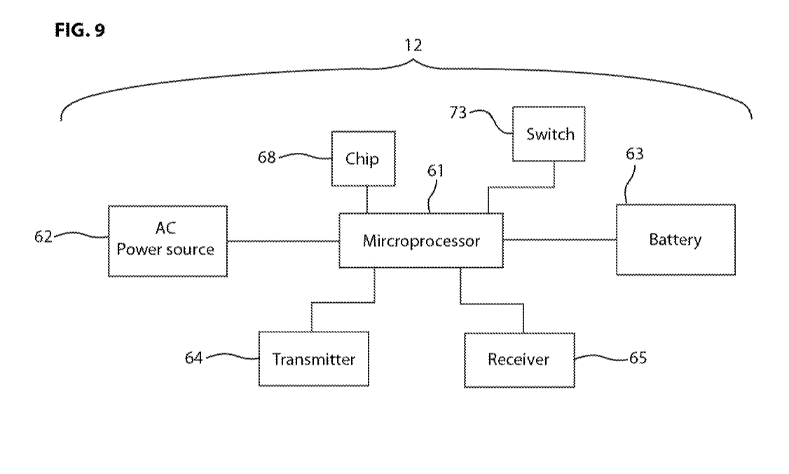

As illustrated in FIG. 9, the emitter 12 may have a microprocessor 61 that may be housed within the emitter 12 and/or secured to the emitter 12. The microprocessor 61 may be connected to an AC power source 62 and/or may be powered by the AC power source 62. For example, the AC power source 62 may be an AC power adapter that may be connected to an AC power outlet. In an embodiment of the present invention, the microprocessor 61 and/or the emitter 12 may be powered by a battery 63. The microprocessor may be programmed to wirelessly communicate with the head 6 and/or the hub 14. A transmitter 64 may be connected to and/or controlled by the microprocessor 61. The transmitter 64 may wirelessly communicate with the head 6 and/or the hub 14. The transmitter 64 may, for example, transmit signals to the head 6 and/or the emitter 12. Further, a receiver 65 may be connected to the microprocessor 72. The receiver 65 may wirelessly communicate with the head 6 and/or the hub 14. For example, the receiver 65 may receive signals that may be transmitted by the head 6 and/or the emitter 12.

As illustrated in FIG. 6, the hub 14 may transmit a signal 15 to the emitter 12. The signal 15 may be, for example, a high frequency radio signal. The emitter 12 may receive the signal 15 from the hub 14. After receiving the signal 15 from the hub 14, the emitter 12 may wirelessly transmit a signal 13 that may be, for example, a low frequency radio signal. The emitter 12 may transmit the signal 13 to define the zone 30 that may extend from the emitter 12. As illustrated in FIGS. 2, 3, 10 and 11, the zone 30 may extend a distance from the emitter 12 and/or may surround the display 60. For example, the zone 30 may extend five feet to ten feet from the emitter 12.

As illustrated in FIG. 9, a switch 73 may be connected to the microprocessor 61 and/or may adjust a frequency and/or a strength of the signal 13. The switch 73 may be, for example, a dual in-line package switch and/or the like and/or may allow the emitter 12 to transmit the signal 13 at various frequencies. A strength of the signal 13 may be adjusted by changing a drive voltage of the transmitter 64, by adjusting the frequency of the signal 13 and/or by adjusting a duty cycle of signal 13. In an embodiment, the retail store employee and/or another individual may operate the switch 73 to adjust the frequency and/or the strength of the signal 13.

Upon removal of the head 6 and/or the device 8 from the zone 30, the head 6 may trigger a first alarm that may be a first audible signal and/or a first visible signal. The first audible signal and/or the first visible signal may alert the individual to return the head 6 and/or the device 8 to the zone 30. As illustrated in FIGS. 5 and 8, the head 6 may have a light 20 that may be housed within the head 6 and/or may be secured to the head 6. In addition, the light 20 may be connected to the microprocessor 35 and/or may be controlled by the microprocessor 35. The light 20 may be, for example, a light-emitting diode (“LED”) and/or the like. The light 20 may be powered by the battery 24. The light 20 may emit the first visible signal to alert the individual that the first alarm may be triggered. For example, the light 20 may illuminate upon removal of the head 6 and/or the device 8 from the zone 30. The first alarm may be deactivated when the receiver 82 may receive the signal 13 from the emitter 12 and/or the microprocessor 35 determines that the head 6 and/or the device 8 may be located within the zone 30. Deactivation of the first alarm may indicate that the head 6 and/or the device 8 may be located within the zone 30. For example, the light 20 may turn off when the receiver 82 may receive the signal 13 and/or the microprocessor 35 determines that the head 6 and/or the device 8 may be located within the zone 30.

Moreover, as illustrated in FIGS. 5 and 8, the head 6 may have a speaker 22 that may be housed within the head 6 and/or may be secured to the head. The speaker 22 may be connected to the microprocessor 35 and/or may be controlled by the microprocessor 35. In addition, the speaker 22 may be powered by the battery 24. The speaker 22 may provide the first audible signal to alert the individual that the first alarm may be triggered. For example, the speaker 22 may emit the first audible signal upon removal of the head 6 and/or the device 8 from the zone 30. The speaker 22 may turn off when the receiver 82 may receive the signal 13 and/or the microprocessor 35 determines that the head 6 and/or the device 8 may be located within the zone 30.

The microprocessor 35 may be programmed to detect an absence of the signal 13. When the microprocessor 35 detects the absence of the signal 13 for a time that exceeds a threshold of time, the head 6 may transmit a signal 7 to the hub 14. The signal 7, for example, may be a high frequency signal. The threshold, for example, may be ten seconds. When the hub 14 receives the signal 7, a second alarm may be triggered. For example, if the head 6 and/or the device 8 may be located in a position outside of the zone 30 for greater than ten seconds, then the head 6 may transmit the signal 7 to the hub 14 and/or the hub 14 may trigger the second alarm. The second alarm may be a second audible signal and/or a second visible signal. The second alarm may alert, for example, the individual and/or a retail store employee that the head 6 and/or the device 8 has been removed from the zone 30 for the time that exceeds the threshold.

In an embodiment, the system 10 may use a received signal strength indicator (RSSI) of the radio signals to determine a proximity of the head 6 to the zone 30. For example, the microprocessor 35 may be programmed to monitor an RSSI of the signal 13 that may be received by the receiver 82. The RSSI of the signal 13 may be indicative of the proximity of the head 6 to the zone 30. For example, a higher RSSI may indicate that the head 6 may be located in the position inside the zone 30 and/or a lower RSSI may indicate that the head 6 may be located in the position outside of the zone 30. For a particular RSSI, the head 6 may trigger the first alarm and/or the hub 14 may trigger the second alarm.

In an embodiment, the system 10 may use time of flight technology, such as ultra wide band, to determine the proximity of the head 6 to the zone 30 which may extend a first distance from the emitter 12. Each of the head 6, the emitter 12 and/or the hub 14 may have a chip 68 that may be connected to the microprocessor 35, the microprocessor 61 and/or the microprocessor 72. For example, the chip 68 may be a DecaWave® DW1000 communication chip. The registered trademark DecaWave® is owned by DecaWave Ltd. of Ireland. The chip 68 may determine a time of flight (TOF) of the signal 13 from the emitter 12 to the head 6. The TOF may be used to determine a second distance between the emitter 12 and/or the head 6. The second distance may indicate whether the head 6 is located within the zone 30 and/or exterior to the zone 30. For example, if the second distance exceeds a predetermined distance, for example the first distance, then the head 6 may be located outside of the zone 30 and/or the microprocessor 35 may be programmed to trigger the first alarm and/or the second alarm. If the second distance is less than and/or equal to the predetermined distance then the head 6 may be located inside the zone 30 and/or the microprocessor 35 may be programmed to deactivate the first alarm and/or the second alarm. The microprocessor 35, the microprocessor 61 and/or the microprocessor 72 may be programmed to compare the first distance to the second distance to determine if the head 6 and/or the device 8 are located within the zone 30.

As illustrated in FIG. 7, the hub 14 may have a light 40 that may be housed within the hub 14 and/or may be secured to the hub 14. The light 40 may be powered by the AC power source 51 and/or the battery 52 of the hub 14. The light 40 may be, for example, a light-emitting diode (“LED”) and/or the like. The light 40 may emit the second visible signal to alert, for example, the retail store employee that the second alarm may be triggered. For example, the light 40 may illuminate upon removal of the head 6 and/or the device 8 from the zone 30 for the time that exceeds the threshold.

Moreover, as illustrated in FIG. 7, the hub 14 may have a speaker 42 that may be housed within the hub 14 and/or may be secured to the hub 14. The speaker 42 may be powered by the AC power source 51 and/or the battery 52 of the hub 14. The speaker may be connected to the microprocessor 72 and/or may be controlled by the microprocessor 72. The speaker 42 may emit the second audible signal to alert, for example, the retail store employee that the second alarm may be triggered. For example, the speaker 42 may emit the second audible signal upon removal of the head 6 and/or the device 8 from the zone 30 for the time that exceeds the threshold.

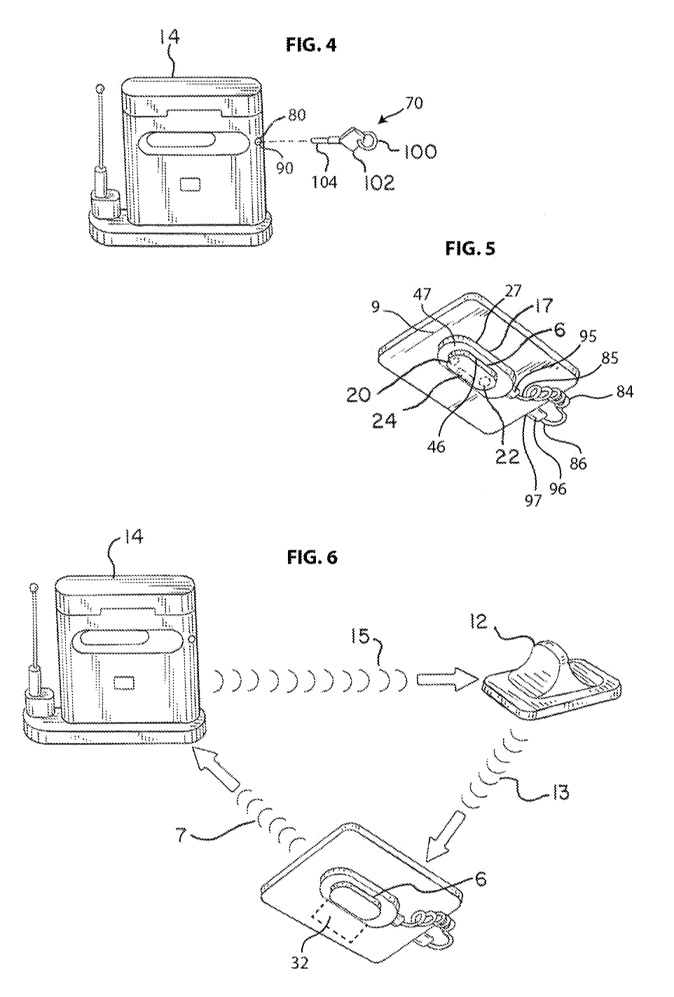

As illustrated in FIG. 4, the hub 14 may have a keyhole 80 that may be defined by an aperture 90 that may extend into the hub 14. The aperture 90 may be sized to receive a key 70 that may be used to disarm the first alarm and/or the second alarm. The key 70 may have a microchip (not shown) that may use radio frequency identification technology and/or may store a unique serial number associated with the key 70. The microprocessor 72 may be programmed to read the serial number that may be associated with the key 70. The microprocessor 72 may have a memory (not shown) that may store the serial number that may be associated with the key 70. The first alarm and/or the second alarm may be disarmed by inserting the key 70 into the keyhole 80. After inserting the key 70 into the keyhole 80, the microprocessor 72 may be programmed to recognize the serial number associated with the key 70 and/or may be programmed to disarm the first alarm and/or the second alarm. The light 40 and/or the speaker 42 may turn off when the key 70 may be inserted into the keyhole 80 of the hub 14.

Moreover, as illustrated in FIG. 4, the key 70 may have a barrel pin 104 that may be sized to fit into the aperture 90 of the keyhole 80. The microchip of the key 70 may be secured within and/or on the barrel tip 104. In addition, as illustrated in FIG. 4, the key 70 may have a key ring 100 and/or a handle 102 that may allow, for example, the retail store employee to carry the key 70.

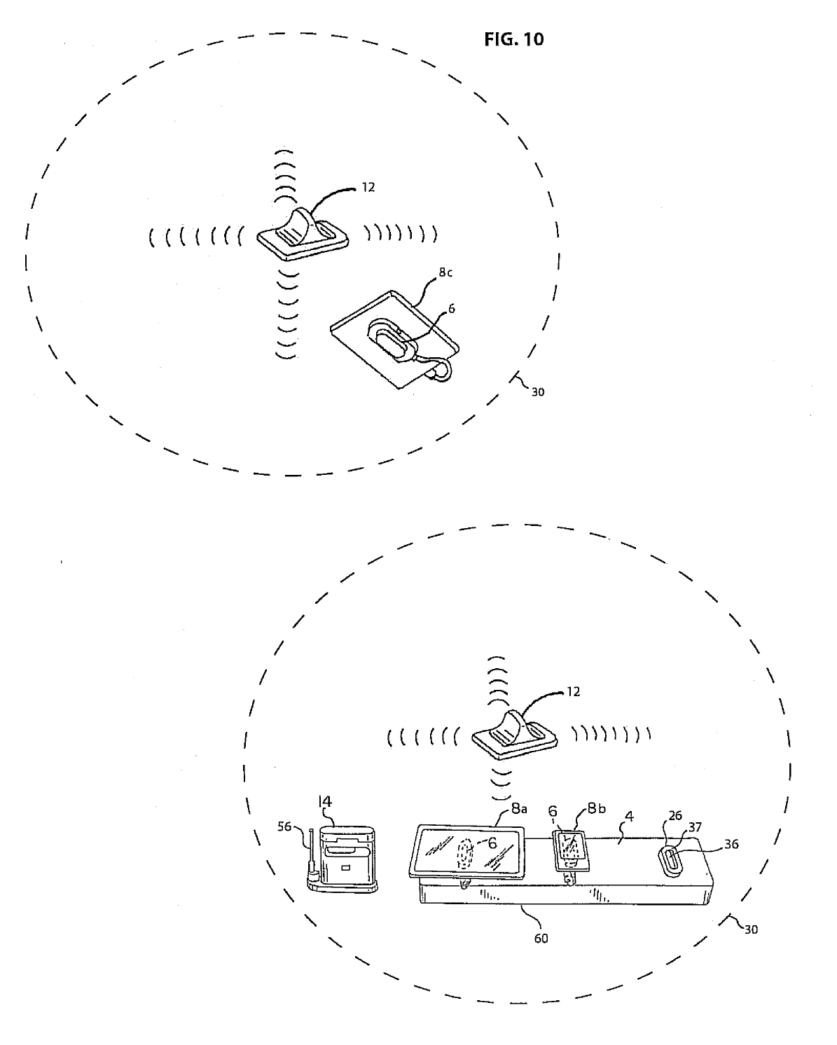

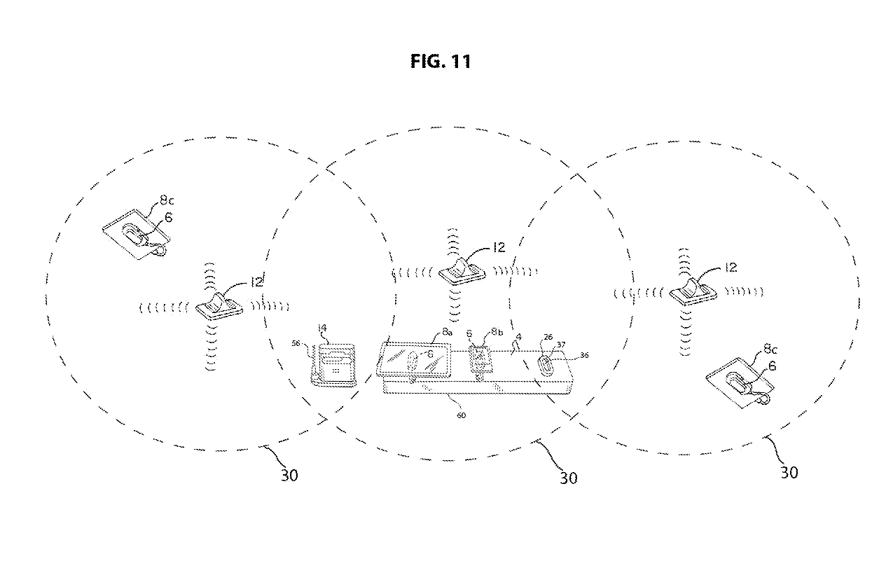

In an embodiment of the present invention, multiple emitters may wirelessly communicate with the hub 14 to transmit radio signals that may establish multiple zones 30, as illustrated in FIGS. 10 and 11. The multiple zones 30 may extend from a corresponding one of the multiple emitters 12. The multiple emitters 12 may be arranged to create various sizes of the multiple zones 30. Arranging a larger number of the multiple emitters 12 closer to each other may create a larger zone than arranging a smaller number of the multiple emitters 12 further apart from each other. When the multiple zones 30 are adjacent and/or overlapping, the radio signals transmitted by the multiple emitters 12 may combine which may form the larger zone.

Movement of the head 6 and/or the device 8 may be permitted within the multiple zones 30. As illustrated in FIG. 10, one or more of the multiple zones 30 may surround and/or be adjacent to the display 60 of the device 8. In addition, as illustrated in FIG. 10, one or more of the multiple zones 30 may not contact one or more of the multiple zones 30. The retail store employee may transfer the head 6 and/or the device 8 between one of the multiple zones that is not in contact with one of the multiple zones without triggering the first alarm and/or the second alarm. The key 70 may be inserted into the keyhole 80 of the hub 14 to deactivate the first alarm and/or the second alarm. While the first alarm and/or the second alarm are deactivated, for example, the retail store employee may remove the head 6 and/or the device 8 from one or more of the multiple zones 30. Then, for example, the retail store employee may place the head 6 and/or the device 8 in another one or more of the multiple zones 30. To reactivate the first alarm and/or the second alarm, for example, the retail store employee may remove the key 70 from the keyhole 80 of the hub 14 to reactivate the first alarm and/or the second alarm.

In an embodiment of the present invention, the multiple emitters 12 may be arranged so that one or more of the multiple zones 30 may overlap and/or be adjacent to each other, as illustrated in FIG. 11. One or more of the multiple zones 30 may surround and/or be adjacent to the display 60. Movement of the head 6 and/or the device 8 may be permitted within the multiple zones 30. When the multiple zones 30 overlap and/or are adjacent to each other, movement of the head 6 and/or the device 8 may be permitted within a greater distance from the display 60 of the device 8 than within one of the multiple zones 30. Removing the head 6 and/or the device 8 from the multiple zones 30 may trigger the first alarm and/or the second alarm.

The head 6 and/or the device 8 may be docked on the display 60, for example, in a retail environment. The individual may use the device 8 within the zone 30. If the individual removes the head 6 and/or the device 8 from the zone 30, then the head 6 may trigger the first alarm. If the individual removes the head 6 and/or the device 8 from the zone 30 for the time that exceeds the threshold, then the hub 14 may trigger the second alarm. The second alarm may be disarmed using the key 70.

In an embodiment, the device 8 may have a battery 32 that may power the device 8 and/or may receive power from the head 6. The microprocessor 35 of the head 6 may be programmed to determine a charge of the battery 32 in the device 8 and/or a charge of the battery 24 in the head 6, such as, for example, completely charged, seventy-five percent charged, fifty percent charged and/or other amounts of charge. After determining the charge of the battery 32 and/or the charge of the battery 24, the microprocessor 35 may be programmed to disconnect power to the battery 32 and/or the battery for an amount of time, for example, one hour. After disconnecting power for the amount of time, power may be reconnected and/or the battery 32 and/or the battery 24 may resume charging which may increase a usable lifetime of the battery 32 and/or the battery 24.

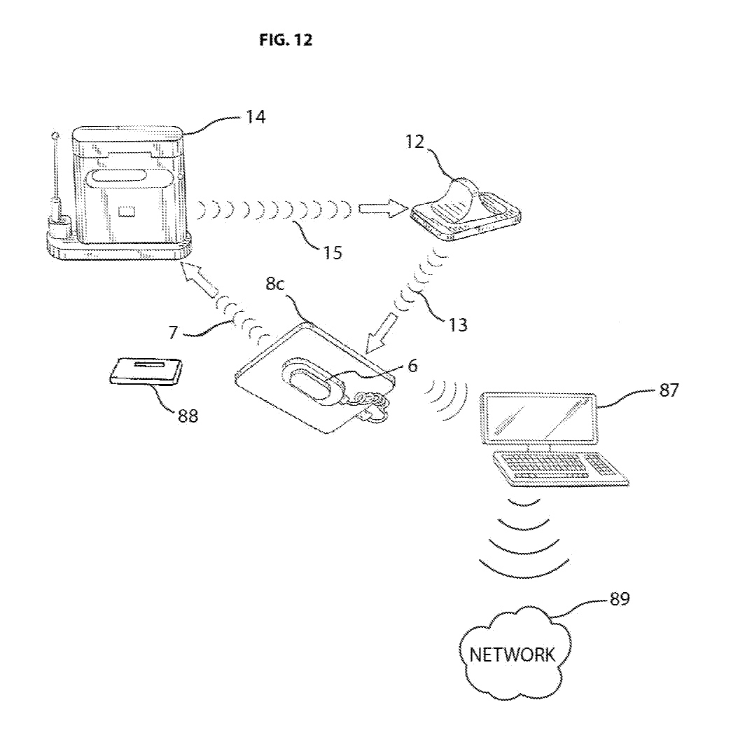

As illustrated in FIG. 8, in an embodiment, the head 6 may have an accelerometer 67 that may be connected to the microprocessor 35. The accelerometer 67 may determine motion data of the head 6 and/or the device 8, such as, for example, an indication of whether the head 6 and/or the device 8 have been moved and/or docked on the display 60, a time of movement and/or a path of movement. Further, the accelerometer 67 and/or the microprocessor 35 may be programmed to process motion-based commands and, as a result, the head 6, the emitter 12 and/or the hub 14 may transmit data, for example, to a computer 87, to a packet analyzer 88 and/or to a network 89. In an embodiment, the network 89 may be a network of servers, such as, the cloud and/or the internet. As shown in FIG. 12, in an embodiment, the computer 87, the packet analyzer 88 and/or the network 89 may communicate with each other wirelessly.

The head 6, the emitter 12 and/or the hub 14 may transmit wireless signals to and/or from each other in accordance with a wireless networking protocol, such as, for example, IEEE 802.11, IEEE802.15.4-2011, Bluetooth® (registered trademark of Bluetooth SIG, Inc.), Wi-Fi® (registered trademark of Wi-Fi Alliance) and/or the like. Further, as shown in FIG. 12, the head 6, the emitter 12 and/or the hub 14 may transmit the wireless signals, for example, to the computer 87, the packet analyzer 88 and/or the network 89. For example, the head 6, the emitter 12, and/or the hub 14 may transmit identifying information of the head 6 and/or the device 8 such as, for example, a serial number that may be associated with the head 6 and/or the device 8, a manufacturer of the head 6 and/or the device 8, and/or a model of the head 6 and/or the device 8. Further, for example, the head 6, the emitter 12 and/or the hub 14 may transmit data corresponding to a position of the head 6 and/or the device 8 and/or to a status of various alarms to the computer 87, the packet analyzer 88 and/or the network 89. A cellular modem may facilitate wireless communication between the computer and/or the network.

In an embodiment, the head 6 may have a plunger 45 which may be connected to the microprocessor 35, as shown in FIG. 8. The plunger 45 may extend from the head 6 in a first position and/or be depressed into the head 6 in a second position when the device 8 is connected to the head 6. For example, in the first position, the plunger 45 may extend from the surface 17. In the second position of the plunger 45, for example, the device 8 may be attached to the head 6 such that the bottom surface 9 may depress the plunger 45. The microprocessor 35 may be programmed to detect removal of the device 8 from the head 6 and/or may be programmed to trigger a third alarm in the first position of the plunger 45. The third alarm may be indicative of a separation, such as, a physical separation, of the device 8 from the head 6 which may illuminate the light 20 and/or activate the speaker 22. For example, if the device 8 is removed from the head 6, then the plunger 45 may extend from the head 6 which may trigger the third alarm.

In an embodiment, an auxiliary plunger (not shown) may be attached to the device 8 and/or may be connected to the head 6 and/or the microprocessor 35 via a cable (not shown). The microprocessor 35 may be programmed to detect an attachment of the cable and/or the auxiliary plunger to the head 6 and/or the device 8. Removing the auxiliary plunger from the head 6 and/or the device 8 and/or disconnecting the cable from the auxiliary plunger and/or the head 6 may trigger the third alarm.

As illustrated in FIG. 5, the device 8 may have a port 97 that may receive the second plug 96. Power may flow from the head 6 through the cable 84 and/or to the port 97 which may be a USB port and/or the like. As illustrated in FIG. 8, the head 6 may have circuitry 57 that may measure parameters at the port 97, such as, for example, a capacitance, a voltage and/or a current. In an embodiment, the microprocessor 35 may be programmed to monitor changes in the parameters at the port 97 which may indicate a connection and/or a disconnection of the cable 84 to the device 8 and/or the head 6. For example, the microprocessor 35 may be programmed to determine that the changes in the capacitance, the voltage and/or the current at the port 97 may be caused by disconnection of the cable 84, charging of the device 8 and/or changes of a load of the device 8. If the changes are caused by disconnection of the cable 84, the microprocessor 35 may be programmed to trigger a fourth alarm which may illuminate the light 20 and/or activate the speaker 22.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. An apparatus for monitoring a device within a first zone wherein the device is located inside of the first zone in a first position and further wherein the device is located outside of the first zone in a second position, the apparatus comprising:
a first emitter having a first transmitter that transmits a first signal to establish the first zone that extends from the first emitter;
a head connected to the device wherein the head wirelessly communicates with the first emitter wherein the head has a first receiver that receives the first signal of a first strength indicative of the head in the first position and receives a second signal of a second strength indicative of the head in the second position wherein the head triggers a first alarm in the second position; and
a hub wirelessly communicating with the first emitter and the head wherein the hub has a second receiver that receives the second signal and further wherein the hub triggers a second alarm in the second position of the head.

2. The apparatus of claim 1 further comprising:
a cable having a length defined between a first end and a second end wherein the first end is connected to the device and the second end is connected to the head wherein the head provides power to the device through the cable.

3. The apparatus of claim 1 further comprising:
a cradle having a recess defined to house the head in a docked position of the head wherein cradle provides power to the head in the docked position wherein the head is removable from the cradle.

4. The apparatus of claim 1 further comprising:
a second emitter having a second transmitter that wirelessly communicates with the head and establishes a second zone and further wherein the second zone is adjacent to the first zone.

5. The apparatus of claim 1 further comprising:
a battery having a charge and that powers the device wherein the head detects the charge of the battery.

6. The apparatus of claim 1 further comprising:
a plunger associated with the head wherein the plunger extends from the head and triggers a third alarm indicative of separation of the head from the device.

7. The apparatus of claim 1 further comprising:
a switch associated with the first emitter that adjusts a frequency of the first signal.

8. The apparatus of claim 1 further comprising:
a circuit in the head configured to measure a voltage, a current and a capacitance at a port of the device.

9. The apparatus of claim 1 further comprising:
an acceloremeter associated with the head wherein the acceloremeter indicates movement of the head.

10. A system for determining a proximity of a device to a first zone, the system comprising:
a first emitter having a first receiver that receives a first signal and a first transmitter that transmits a second signal to establish the first zone that extends from the first emitter;
a head secured to the device wherein the head wirelessly communicates with the first emitter and has a second receiver that receives the second signal wherein the head calculates a distance between the head and the first emitter by determining a time the second signal travels between the first transmitter and the second receiver wherein the distance is indicative of a position of the head and further wherein the head triggers an alarm indicative of the head in a position outside of the first zone; and
a hub wirelessly communicating with the first emitter and the head wherein the head transmits a third signal to the hub that is indicative of the device in the position outside of the first zone.

11. The system of claim 10 further comprising:
a cable having a length defined between a first end and a second end wherein the first end is connected to the device and the second end is connected to the head wherein the head triggers a second alarm indicative of a disconnection of the cable.

12. The system of claim 10 further comprising:
a speaker in the head wherein the speaker emits an audible alert.

13. The system of claim 10 further comprising:
a second emitter having a second transmitter wherein the second emitter wirelessly communicates with the head and establishes a second zone and further wherein the second zone intersects with the first zone.

14. The system of claim 10 further comprising:
a key that inserts into the hub to deactivate the alarm.

15. A method for monitoring a device within a zone wherein the device wirelessly communicates with a first emitter and a hub and further wherein the zone extends a first distance from the first emitter, the method comprising the steps of:
transmitting a signal wirelessly from the first emitter to define the zone wherein the first signal has a frequency;
calculating a second distance between the first emitter and the device;
comparing the first distance to the second distance; and
triggering a first alarm if the second distance is greater than the first distance wherein the first alarm is indicative of the device in a position outside of the zone.

16. The method of claim 15 further comprising the step of:
triggering a second alarm indicative of the device in the position located outside of the zone.

17. The method of claim 15 further comprising the step of:
adjusting the frequency of the signal.

18. The method of claim 15 further comprising the step of:
transmitting identification information of the device wherein the identification information is a manufacturer of the device and/or a model of the device.

19. The method of claim 15 further comprising the step of:
monitoring a voltage, a capacitance and/or a current of the device.

20. The method of claim 15 further comprising the step of:
deactivating the first alarm if the second distance is less than the first distance.
